(19) United States
(12) Patent Application Publication
(10) Pub. No.: US 2012/0132790 A1
(43) Pub. Date: May 31, 2012

(54) ELECTRONIC DEVICE HAVING PROXIMITY DETECTION FUNCTION

(75) Inventors: CHEN-CHOU HUANG, Tu-Cheng (TW); CHUN-YU LEE, Tu-Cheng (TW)

(73) Assignee: HON HAI PRECISION INDUSTRY CO., LTD., Tu-Cheng (TW)

(21) Appl. No.: 13/095,893

(22) Filed: Apr. 28, 2011

(30) Foreign Application Priority Data
Nov. 30, 2010 (TW) 99141360

(51) Int. Cl. G01J 1/44

(52) U.S. Cl. 250/214.1

(57) ABSTRACT

An electronic device having proximity detection function includes a front cover, a frame arranged under the front cover, a light emitter and a photo sensor received in the frame. A spacer is arranged between the front cover and the frame to prevent a portion of light from the light emitter from travelling to the photo sensor, when the front cover and the frame are not parallel.

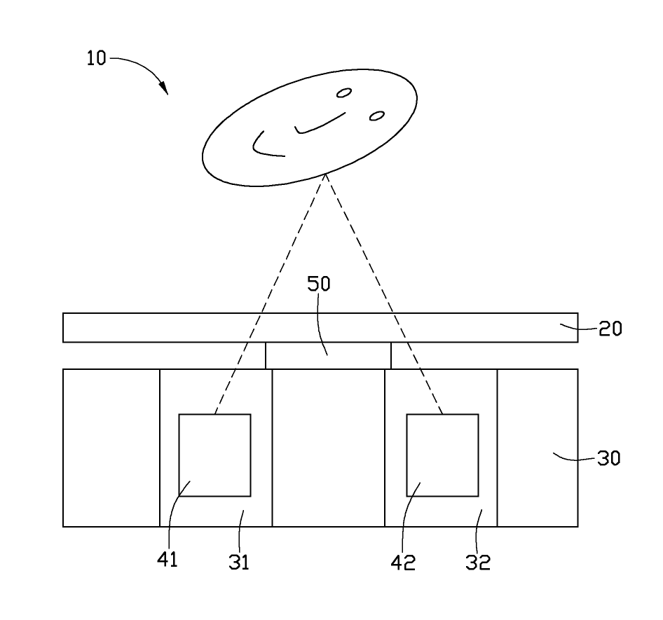

### BACKGROUND

1. Technical Field

The present disclosure relates to an electronic device having proximity detection function.

2. Description of Related Arts

Some mobile phones include an infrared emitter and a corresponding photo sensor. When making a call using such kind of phone, the phone is held adjacent to a user's face. The light beams from the infrared emitter are reflected to the photo sensor. The photo sensor then signals a processor of the mobile phone. The processor then powers off the display of the mobile phone. During manufacturing, the sub-assembly including the display, the light emitter, the photo sensor, the processor, and other required components will be tested after a front cover is attached. One problem during the test is that the displays of some sub-assemblies are always in a power off state after the front cover is attached. That is, some sub-assemblies fail the test and need to be repaired.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

The drawing is a schematic view of an electronic device with proximity detection function, according to an embodiment.

### DETAILED DESCRIPTION

Embodiments of the present disclosure will now be described in detail below, with reference to the accompanying drawings.

Referring to the drawing, an electronic device 10 includes a front cover 20 and a frame 30 arranged under the cover 20. The frame 30 defines two receiving holes 31 and 32. A light emitter 41 and a photo sensor 42 are respectively received in the receiving holes 31 and 32. In the embodiment, the light emitter 41 can emit infrared light beams. When receiving at least a preset amount of light beams from the light emitter 41, the photo sensor 42 signals a processor (not shown) of the electronic device 10.

In the embodiment, the electronic device 10 is a cell phone. When making a call, a user holds the electronic device 10 close to his/her ear. In this situation, the light beams from the light emitter 41 are reflected by the face of the user and travel to the photo sensor 42. When a preset amount of light beams is reflected to the photo sensor 42, the photo sensor 42 signals the processor. The processor then executes a predetermined operation, such as powering off the display (not shown) of the electronic device 10.

Due to manufacture error, the front cover 20 and the frame 30 may not be parallel to each other, which may result in a preset amount of light beams being reflected to the photo sensor 42. The processor then executes a predetermined operation, such as powering off the display.

To avoid the above problem, a spacer 50 is arranged between the front cover 20 and the frame 30. The spacer 50 is arranged between the receiving holes 31 and 32. When the front cover 20 and the frame 30 are properly assembled, the spacer 50 will not block the light beams from the light emitter 41. When the front cover 20 and the frame 30 are not properly assembled and are not parallel to each other, the spacer 50 can block a portion of the light beams from the light emitter 41. As a result, when the electronic device 10 is not in use, the photo sensor 42 will not receive a preset amount of light beams from the light emitter 41.

In the embodiment, the spacer 50 is a sponge. The gap between the front cover 20 and the frame 30 is about 0.15 millimeter, and the distance between the light emitter 41 and the photo sensor 42 is about 0.7 millimeter.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. An electronic device having proximity detection function, the electronic device comprising:
a front cover;
a frame arranged under the front cover;
a light emitter and a photo sensor received in the frame; and
a spacer arranged between the front cover and the frame to prevent a portion of light from the light emitter from travelling to the photo sensor when the front cover and the frame are not parallel.

2. The electronic device according to claim 1, wherein the spacer is a sponge.

3. The electronic device according to claim 1, wherein the frame defines two receiving holes to receive the light emitter and the photo sensor.

4. The electronic device according to claim 3, wherein the spacer is arranged between the two receiving holes.

5. The electronic device according to claim 1, wherein the light emitter is an infrared emitter that is able to emit infrared light beams.

6. The electronic device according to claim 1, wherein the distance between the light emitter and the photo sensor is 0.7 millimeter, and the distance between the front cover and the frame is 0.15 millimeter.
